(19) United States
(12) Patent Application Publication
(10) Pub. No.: US 2022/0414812 A1
(43) Pub. Date: Dec. 29, 2022

(54) EVALUATION OF TRANSITORY ARRANGEMENTS USING NEAR REAL TIME DATA

(71) Applicant: JD Phee & Co., LLC dba WagerFans, Santa Rosa Beach, FL (US)

(72) Inventor: John D. Phee, Copper Canyon, TX (US)

(21) Appl. No.: 17/848,077

(22) Filed: Jun. 23, 2022

Related U.S. Application Data
(60) Provisional application No. 63/214,708, filed on Jun. 24, 2021.

(51) Int. Cl. G06Q 50/34; G07F 17/32

(52) U.S. Cl. CPC G06Q 50/34; G07F 17/3244; G07F 17/3288; G07F 17/3237

(57) ABSTRACT

Techniques may include providing event information and likelihood information to a plurality of user devices each associated with at least one user profile. Techniques may include receiving a request from a first user device. The request may define a arrangement by identifying at least: (i) a first event of the plurality of events, (ii) an amount, (iii) an arrangement type, and (iv) a second user profile. The techniques may include sending the request to a second user device. The request may enable the second user device to present the request. Techniques may include receiving an acceptance notice, from the second user device, indicating acceptance of the arrangement. Techniques may include sending the acceptance notice to the first user device. Techniques may include using updated event information to determine a prevailing user profile with respect to the transitory arrangement, credit the winner's repository and debit the loser's repository.

### CROSS-REFERENCES TO RELATED APPLICATIONS

This application claims the benefit of U.S. Provisional Patent Application No. 63/214,708, filed Jun. 24, 2021, the entire contents of which are hereby incorporated by reference for all purposes in its entirety.

### BRIEF SUMMARY

The techniques disclosed herein relate to a transitory arrangement evaluation system. Various inventive embodiments are described herein, including methods, systems, non-transitory computer-readable media storing programs, code, or instructions executable by one or more processors, and the like.

Techniques may include providing event information that identifies a plurality of predetermined events and likelihood information associated with each of the plurality of predetermined events to a plurality of user devices each associated with at least one user profile. The techniques may in addition include receiving a request that defines a arrangement including arrangement terms that identify at least: (i) a first event of the plurality of events, (ii) an amount, (iii) an arrangement type, and (iv) a second user profile. The arrangement may be received from a first user device of the plurality of user devices associated with a first user profile. Techniques may also include sending the request to a second user device associated with the second user profile. The request can be configured to enable the second user device to present information associated with the request. Techniques may include receiving an acceptance notice from the second user device. The acceptance can indicate user acceptance of the arrangement terms. Techniques may include sending information associated with the acceptance notice to a first user device. Techniques may include receiving updated event information and using the updated event information and the arrangement terms to determine a prevailing user profile with respect to the transitory arrangement. Techniques may include if the first user profile is the winner: increasing a first repository of the first user profile a first amount corresponding to the arrangement amount; and reducing a second repository of the second user profile a second amount equal to the arrangement amount.

Implementations may include one or more of the following techniques. Techniques may include receiving the event information from a real-time event analytics service. The event information may include an aggregation of different likelihood information from a plurality of likelihood services. Techniques may include determining that the first user device is located within an approved geographic location for sports betting prior to sending the request to the second user device. Techniques may include determining that the first user device is located within the approved location by: receiving location information identifying a current location of the first user device from the first user device. The location information can be compared with a list of approved geographic locations that may include the approved geographic location. The technique may include determining the location of the first user device based at least in part on the comparing that the current location is within the approved geographic location. Techniques may include determining that the second user device is located within an approved geographic location for peer-to-peer sports betting prior to sending the request to the second user device. Techniques may include determining that the second user device is located within the approved location by: receiving location information identifying the location of the second user device from the second user device. The location information can be compared with a list of approved geographic locations that may include the approved geographic location. Whether the current location is within the approved geographic location can be determined based at least in part on the comparison. In some techniques, the first user profile or the second user profile can be associated with a contact stored respectively on at least one of the second user device or the first user device. Techniques can include increasing the second repository the first amount corresponding to the arrangement amount; and decreasing the first repository the second amount equal to the arrangement amount if the second repository is the winner. In some techniques, sending the request may include sending a download request that requests downloading of an application on the second user device. Techniques may include: receiving, from the first user device, a debit request that identifies repository details of an external repository associated with the first user profile and a debit amount; confirming the repository details; and requesting that the debit amount be sent to the external repository. Implementations of the described techniques may include hardware, a method or process, or a computer tangible medium.

Techniques may include sending location information to the remote server that identifies a current location of the user device. The location information can be configured to enable the remote server to determine whether to accept or reject the request. In some techniques, the second user profile is associated with a contact of the first user profile and that is stored on the user device. In some techniques, the request is configured to enable the remote server to share the request with a different user device associated with the second user profile. In some techniques, the likelihood information identifies at least one of an over/under for each predetermined event or a point spread for each predetermined event. In some techniques, sending the request occurs at a first time and receiving the information indicating the winner of the arrangement occurs at a second time that is later than the first time. Implementations of the described techniques may include hardware, a method or process, or a computer tangible medium.

### BRIEF DESCRIPTION OF THE DRAWINGS

FIG. 1 illustrates an example architecture or system 100 for implementing a transitory arrangement evaluation system, according to at least one example.

FIG. 2 illustrates example user interface views of a transitory arrangement evaluation system as viewed at a user device, according to at least one example.

FIG. 3 illustrates example user interface views of a transitory arrangement evaluation system as viewed at a user device, according to at least one example.

FIG. 4 illustrates example user interface views of a transitory arrangement evaluation system as viewed at a user device, according to at least one example.

FIG. 5 illustrates example user interface views of a transitory arrangement evaluation system as viewed at a user device, according to at least one example.

FIG. 6 illustrates example user interface views of a transitory arrangement evaluation system as viewed at a user device, according to at least one example.

FIG. 7 illustrates an example flow chart depicting the process for processing a request using a transitory arrangement evaluation system, according to at least one example.

FIG. 8 illustrates an example flow chart depicting the process for processing a request using a transitory arrangement evaluation system, according to at least one example.

FIG. 9 illustrates an example flow chart depicting the process for processing a request using a transitory arrangement evaluation system, according to at least one example.

### DETAILED DESCRIPTION

Examples are described herein in the context of an online transitory arrangement evaluation system (e.g., a peer-to-peer wager system) in the context of transitory arrangements between friends (e.g., wagers) relating to sporting events. Those of ordinary skill in the art will realize that the following description is illustrative only and is not intended to be in any way limiting. For example, the techniques described herein can be used to place facilitate and evaluate transitory arrangements on things other than formal sporting events such as, for example, transitory arrangements between friends on the golf course, etc.

Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and other-related constraints, and that these specific goals will vary from one implementation to another and from one developer to another.

In an illustrative example, systems, devices, and corresponding techniques described herein may facilitate the online transitory arrangement evaluation system. Unlike conventional online arrangement systems in which the arrangement is against the house (e.g., a casino), the techniques described herein provide for facilitating arrangements between users that are have some previous connection (e.g., those that friends). Such users, in some examples, may be users who are known to each other. Whether a person is known to the other person may depend on whether the person's contact information (e.g., phone number, email address, etc.) is stored by the other person on a user device, whether the people are connected via social media platform, and the like. In this case, the described transitory arrangement system may enable friends, family members, and other close associates to make transitory arrangements against each other in a fun and trusted manner. The transitory arrangement system may be considered trustworthy because it authenticates the users, provides reliable information upon which users can rely when making arrangements, acts as an escrow system while an arrangement is pending (e.g., between when the arrangement is made and the event ends), and maintains secure financial accounts (e.g., repositories) for system users.

The described transitory arrangement system in particular may enable betting against friends on particular events such as sporting events. In some examples, unlike conventional betting platforms that take high amounts (e.g., in the form of fees) from the person placing the arrangement, the described transitory arrangement system is used to exact identical amounts from both parties (e.g., the user proposing the wager and the user accepting the proposal). For example, each user may be exacted an amount of between one and five percent of the placed arrangement. In a particular example, the amount may be 2.5%. Thus, for a wager of $10 between user A and user B, the service provider (e.g., entity that operates the service provider) may take a processing amount of 25 cents from each of user A and user B for total of 50 cents. In this example, assuming user A prevails with respect to the arrangement, user A would get an increase of $19.50 and user B would get a decrease of $10.

The described transitory arrangement system may be implemented using a backend server (e.g., a service provider) and a plurality of user devices, each of which may be executing an application (e.g., a specialized App, web application, or the like). Generally, the backend server may serve information to the user devices and receive and process requests from the user devices.

Techniques described herein provide several technical advantages over a conventional transitory arrangement evaluation system. Arrangements between friends can be streamlined, and made less contentious, by displaying information about the arrangements via a user interface. Likelihood information (e.g., odds information) can be retrieved from a likelihood service (oddsmaker service) by the transitory arrangement system and displayed to each party to an arrangement via a user interface thereby increasing trust that the terms of an arrangement have not been skewed in one party's favor. In addition, existing arrangements, and past arrangements, between users can be displayed as part of a curated and configurable record. The arrangement evaluation system can retrieve event information from the real time analytics service and declare an arrangement winner without requiring further user input.

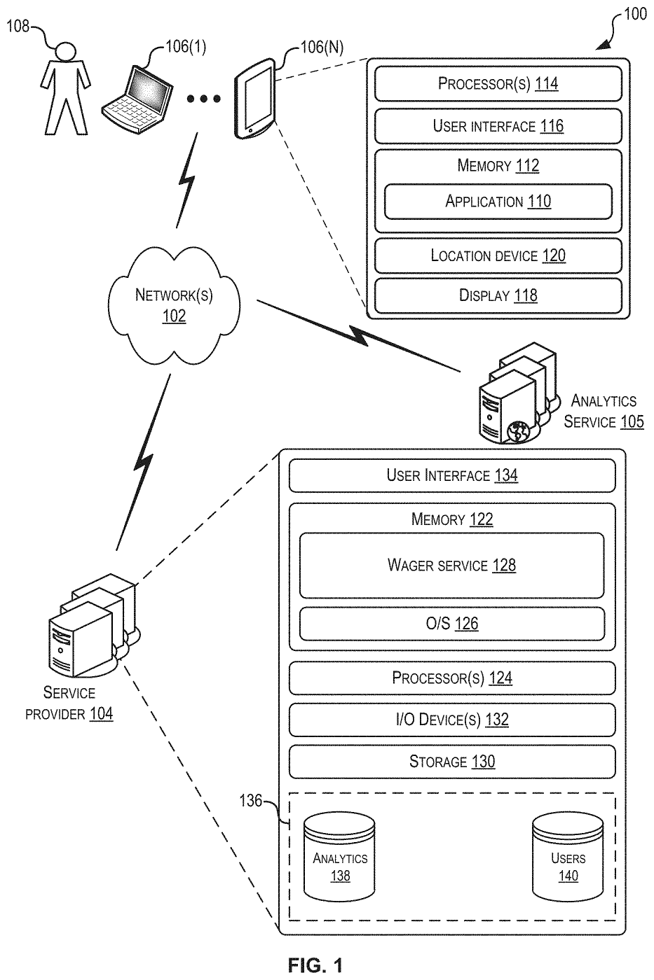

Turning now to the Figures, FIG. 1 illustrates an example architecture or system 100 for implementing a transitory arrangement evaluation system, according to at least one example. The system 100 may include a service provider 104 in communication with one or more user devices 106(1)-106(N) (hereinafter, “the user device 106”) via one or more networks 102 (hereinafter, “the network 102”). The system 100 may also include an analytics services 105 in communication with the service provider 104 and, in some examples, the user device 106.

As described herein, the service provider 104 may include any suitable combination of hardware and software resources configured to implement the techniques described herein. For example, the service provider 104 may be a web server configured to provide a web application, a web interface, application programming interfaces, and the like over one or more networks (e.g., the network 102). The service provider 104 may be implemented using a Cloud-computing environment. Thus, the elements described with respect to the service provider 104 may represent one or more virtual computers.

The user device 106 may be operable by one or more users 108 (hereinafter, “the user 108”) to interact with the service provider 104. For example, the users 108 may use an application 110 executing on the user devices 106 to communicate with the service provider 104. The network 102 may include any one or a combination of many different types of networks, such as cable networks, the Internet, wireless networks, cellular networks, and other private and/or public networks. The user 108 may be any suitable user that is capable of using the system 100. In some examples, the service provider 104 and/or the application 110 may include functionality to confirm that the age of the user 108 is suitable for participating in the arrangements described herein.

Turning now to the details of the user device 106, the user device 106 may be any suitable type of computing device such as, but not limited to, a digital camera, a wearable device, a tablet, a mobile phone, a smart phone, a personal digital assistant (PDA), a laptop computer, a desktop computer, a thin-client device, a tablet computer, a set-top box, or any other suitable device capable of communicating with the service provider 104 via the network 102 or any other suitable network. For example, the user device 106(1) is illustrated as an example of a laptop, while the user device 106(N) is illustrated as an example of a smart phone. The user device could be a smart watch, a smart television or streaming device (e.g., apple TV). An application running on a smart television, streaming device, or another suitable device could integrate the application with broadcast events.

The user device 106 may include the application 110 within memory 112. Within the memory 112 of the user device 106 may be stored program instructions that are loadable and executable on processor(s) 114, as well as data generated during the execution of these programs. Depending on the configuration and type of user device 106, the memory 112 may be volatile (such as random access memory (RAM)) and/or non-volatile (such as read-only memory (ROM), flash memory, etc.). The application 110, stored in the memory 112, may allow the user 108 to interact with the service provider 104 via the network 102. Such interactions may include, for example, creating a user profile, submitting arrangement requests (e.g., wagers), tracking statuses of arrangement requests, adding money to a virtual wallet/account maintained or hosted by the service provider 104, retrieving money from the virtual wallet, managing user preferences associated with the user 108 and/or any of the user devices 106, and any other suitable client-server interactions. The service provider 104 may host the application 110.

The user device 106 may also include one or more user interfaces 116 for interacting with the user device. In some examples, the user interfaces 116 may include graphical user interfaces, input/output interfaces, and the like. For example, a user interface 116 may be presented by the user device 106 on a display of the user device 106. The display 106, which may be a touchscreen, may be used to interact with the user interface 116. The user device 106 may also include a location device 120 capable of determining a real-world location of the user device 106 at any given time. For example, the location device 120 may include a global positioning chip or other suitable location sensor. The location device 120 may share location information with the application 110 and/or the service provider 104, as appropriate. In some examples, the application 110 may only be used to place arrangements (e.g., wagers) when the user is located within geographic region that is approved for sports betting. In some examples, the application 110 may only be used to accept transitory arrangement proposals (e.g., wagers) when the user is located within a geographic region that is approved for transitory arrangements (e.g., sports bets). In some examples, the application 110 may only be used to place transitory arrangement proposals when the user placing the transitory arrangement proposal and a user receiving the proposal, who can accept or reject the proposal, are located in the same geographic region that is approved for transitory arrangements. In some examples, the location device 120 may be used by the application to make a binary determination of whether the user device 106 (and thereby the user) are located in a particular region (e.g., a first state) or a different region (e.g., a second state). In some examples, the application 110 may be used to make non-money proposals, irrespective of the location of the user device 106. For example, the application 110 may be used to make non-money transitory arrangement proposals with friends using points, fake money, or the like rather than actual money.

Turning now to the details of the service provider 104, the service provider 104 may include one or more service provider computers, perhaps arranged in a cluster of servers or as a server farm, and may host web service applications. These servers may be configured to host a website (or combination of websites), web services, applications, etc. viewable on the user device 106 (e.g., via the application 110).

The service provider 104 may include at least one memory 122 and one or more processing units (or processor(s)) 124. The processor 124 may be implemented as appropriate in hardware, computer-executable instructions, software, firmware, or combinations thereof. Computer-executable instruction, software, or firmware implementations of the processor 124 may include computer-executable or machine-executable instructions written in any suitable programming language to perform the various functions described. The memory 122 may include more than one memory and may be distributed throughout the service provider 104. The memory 122 may store program instructions that are loadable and executable on the processor(s) 124, as well as data generated during the execution of these programs. Depending on the configuration and type of memory including the service provider 104, the memory 122 may be volatile (such as random access memory (RAM)) and/or non-volatile (such as read-only memory (ROM), flash memory, or other memory). The memory 122 may include an operating system 126 and one or more application programs, modules, or services for implementing the features disclosed herein including at least an arrangement service 128 (e.g., a wager service).

The service provider 104 may also include additional storage 130, which may be removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. The additional storage 130, both removable and non-removable, is examples of computer-readable storage media. For example, computer-readable storage media may include volatile or non-volatile, removable or non-removable media implemented in any suitable method or technology for storage of information such as computer-readable instructions, data structures, program modules, or other data. As used herein, modules, services, engines, and components, may refer to programming modules executed by computing systems (e.g., processors) that are part of the service provider 104 and/or the user device 106.

The service provider 104 may also include input/output (I/O) device(s) and/or ports 132, such as for enabling connection with a keyboard, a mouse, a pen, a voice input device, a touch input device, a display, speakers, a printer, or other I/O device.

The service provider 104 may also include a user interface 134. The user interface 134 may be utilized by an operator or other authorized user to access portions of the service provider 104. In some examples, the user interface 134 may include a graphical user interface, web-based applications, programmatic interfaces such as application programming interfaces (APIs), or other user interface configurations. The service provider 104 may also include a data store 136. In some examples, the data store 136 may include one or more data stores, databases, data structures, or the like for storing and/or retaining information associated with the service provider 104. For example, the data store 136 may include databases such as an analytics database 138 and a user database 140.

The analytics database 138 may include event analytics information received from the analytics service 105. In some examples, the event analytics information may processed by the service provider 104 prior to be being stored in the analytics database 138. In some examples, the analytics service 105 provides a data feed that the service provider 104 is subscribed to. In this example, the service provider 104 may or may not store the information received from the analytics service 105 in the database 138. In some examples, the analytics database 138 may be used to store historical analytics information received from the service 105 and/or otherwise generated by the service provider 104. For example, the service provider 104 may enable likelihood services or other such users to generate its own event analytics information in addition to or instead of also receiving the information from the analytics service 105.

In some examples, the analytics service 105 may aggregate likelihood (e.g., odds) information from different likelihood services and from different event scheduling services. This may enable the analytics service 105 to provide likelihood information and event information to the service provider 104 and/or the user device 106. The analytics service 105 provide a real-time data feed (e.g., within a minute) of the actual events. The analytics service 105 may be certified by a certifying body to provide data feeds of the type described herein (e.g., event information and likelihood information).

The event analytics information may include any suitable information associated with an event that can be bet upon, likelihood information for different types of arrangements, and the like. For example, the event analytics information may include a schedule of events to be played (e.g., football, baseball, basketball, boxing, Olympic sports, hockey, wrestling, mixed martial arts, and any other suitable sporting event that may be scheduled), likelihood information as appropriate for the different sports (e.g., over/under, point spread, handicap, straight bets, total line bets, money line bets, parlay bets, teaser bets, head-to-head bets, and any other suitable bet type).

The user database 140 may be used to store user profile information for users of the service provider 104. This may include users 108 that have registered with the service provider 104. In some examples, the user profiles may include generally static information such as age information (to confirm that the user is an adult), authoritative documentary age information (e.g., a driver's license or government issued ID), address, credentials, payment accounts, transfer accounts, etc. The user profiles may also include more dynamic information such as a history of arrangements, an arrangements profile (e.g., how the user prefers to bet, etc.), historical information about wins and losses, historical collection of who the user has bet against and when, dynamic location information associated with requests received from the user's associated user device (e.g., to understand where the user was when they requested access to the service provider 104), and any other suitable information for improving the services provided by the service provider 104, for complying with any government regulations relating to the collection of user information and the administration of gambling, and the like.

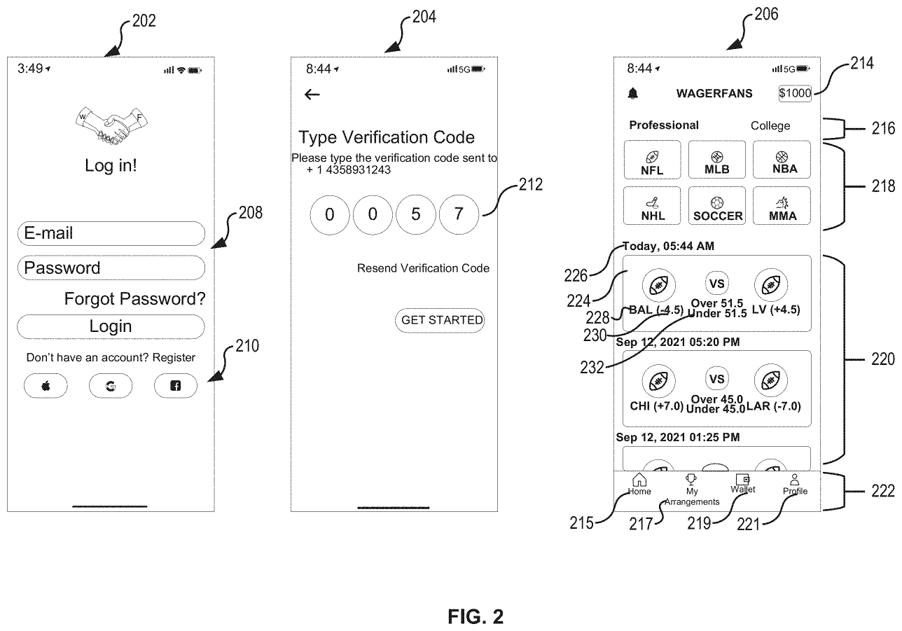

FIG. 2 illustrates example user interface views 202-206 of a transitory arrangement evaluation system as viewed at a user device, according to at least one example. The user interface views 202-206 may be presented at the display 118 of the user device 106 using the application 110 and the arrangement service 128. The user interface views 202 and 204 may be used to for a user to log into the application 110 and/or the transitory arrangement evaluation system. For example, the user interface view 202 may include a credential input section 208 at which a user may input an email address and password. The user interface view 202 may also include functionality to enable the user to retrieve a forgotten password and register for a new account. The user interface view 202 also includes an option for single sign-on 210 using an existing account such as is common in the art. The user interface view 204 may be used for a user to input a verification code 212 for purposes of multi-factor authentication. Once verified, the user may begin using the application 110 to perform the techniques described herein. The user interface view 206 may include different sections that are used to organize different information. For example, the user interface view 206 may include an account balance 214 (e.g., currently showing $1000).

The user interface view 206 may represent a landing page or home page within the application 110. The user interface view 206 may include a navigation tray 222 used to navigate to different views available within the application 110. The user interface view 206 corresponds to a home view (e.g., the home icon 215 has been selected).

The display 118 of the user device 106 using the application 110 and the arrangement service 128 may present user interface views. The user interface views displayed when a user selects the home icon 215 in the navigation tray 222 can correspond to informational views that would be presented when a user first opens the application 110 and before signing into the application 110. Thus, the user interface views may present information about what the application does, information about how to place an arrangement, information about what occurs once an arrangement has been accepted by a friend, and information about what occurs after the event (e.g., a sports game) upon which the arrangement was based has been completed.

After selecting the my arrangements icon 217 in the navigation tray 222, the user interface 116 can present information about arrangement that the user has placed. In particular, the user interface 116 can include a filter to change between “confirmed” arrangement, “pending” arrangements, and “history” of arrangement. The confirmed filter can include arrangements that have been accepted by friends, but have yet to pay out (e.g., the event has not yet concluded). The pending filter can include arrangements that have been sent to friends, but have not yet been accepted by the friends. The history filter can include arrangements that have been paid out (e.g., the event has concluded). The user interface 116 can present a wallet user interface view responsive to user selection of the wallet icon 219 in the navigation tray 222 described below. The wallet user interface view can include a button or other selector for adding money and one for withdrawing money. The wallet user interface view can also include a history of recent arrangements.

The wallet user interface view can be shown after selecting the wallet icon 219 in the navigation tray 222 and the wallet user interface can be used to add money to the virtual wallet used for making arrangements. In some examples, the virtual wallet may be maintained by the service provider using any suitable banking entity. The virtual wallet may include actual funds available to the user for making arrangements and may be uniquely identifiable by an account number or other identifier. To add money to the virtual wallet, the wallet user interface view can include an amount input field and a bank information input fields.

User selection of the withdrawing money button in the wallet user interface view can be used to withdraw money from the virtual wallet. To do so, the wallet user interface view may include amount input fields, depositing bank details, and a withdraw button. The wallet user interface view can also include an option for setting exposure. This may enable a user to set the total amount of money that they may lose using the transitory arrangement evaluation system. This may be set on a weekly basis, a monthly basis, a daily basis, a yearly basis, or using any other way.

The user interface view 206 also includes a class selector 216 for switching between predefined classes of events. In the illustrated example, the event classes include professional events and college events. Any other suitable type of event class may also be used. Thus, the class selector 216 may be used to select between two, three, four, or more different classes of events.

The user interface view 206 also includes event type selectors 218. The event type selectors 218 may correspond to the selected class of events at 216. In the illustrated example, the event type selectors 218 identify various “professional” events because the professional class selector 216 has been selected by a user. While six professional events are illustrated, others may be presented in the user interface view 206 and/or may be accessible by scrolling the user interface view 206.

The user interface view 206 also includes event selectors 220. The event selectors 220 identify the events corresponding to the selected event type selector 218. Thus, the event selectors 220 visible in the user interface view 206 will change depending on which event type selector 218 is selected by the user. In the illustrated example, the “NFL” event type selector 218 has been selected. Thus, the illustrated event selectors 220 are NFL games. The games may be organized in any suitable order such as ascending in time (e.g., earliest games first), geographically (e.g., games closer to the user's location, presented first), according to a user favorites (e.g., the user's favorited teams may be presented first), and in any other suitable manner.

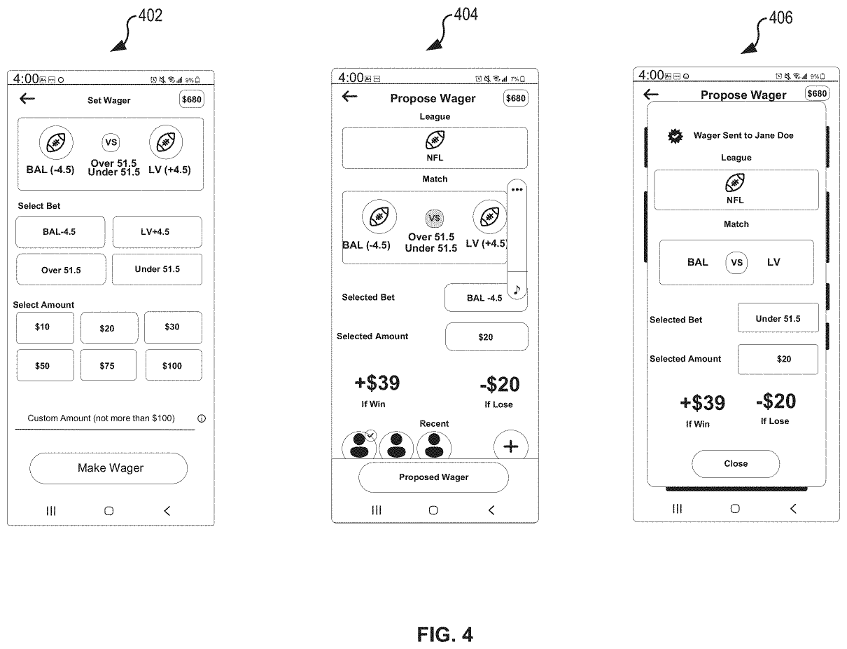

Turning now to a specific event record 224 as an example, the event record 224 generally includes event information and arrangement information. The event information includes, for example, a date and time indicator 226 (e.g., “Today, 05:44 AM”) that indicates the date and time that the event will begin (e.g., when the football game starts) and participant indicators 228 (e.g., “BAL” and “LV”) that identify the participants in the event (e.g., the teams competing in the football game). The arrangement information includes, for example, a first arrangement type 230 (e.g., “(−4.5)”) associated with the participant (e.g., the underdog and the favorite including the point spread in + or −) and a second arrangement type 232 (e.g., “Over 51.5|Under 51.5”) associated with the event (e.g., the over and under for the football game). Depending on the event and the types of arrangements available, the event record 224 may display more or fewer arrangement types. The purpose of the event record 224 is to display sufficient information to enable a user to quickly find an event of interest and assess the possible arrangement types in order to make an informed decision about placing an arrangement proposal. User selection of an event record similar to the event record 224 may cause presentation of a user interface view 402, as described with respect to FIG. 4. Use of the user interface view 402 and subsequent user interface views 404 and 406 may be used to send an arrangement request to a friend.

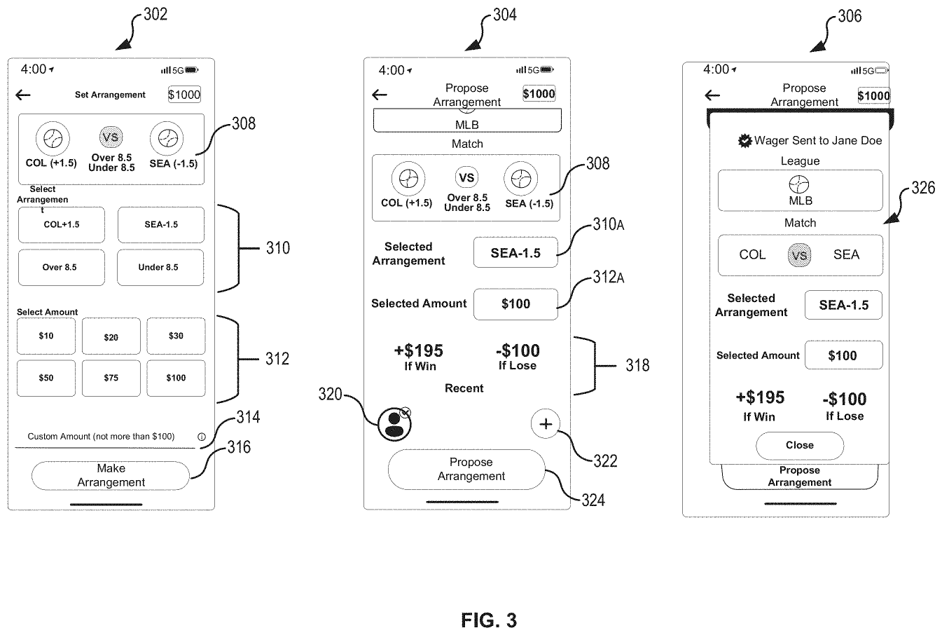

FIG. 3 illustrates example user interface views 302-306 of a transitory arrangement evaluation system as viewed at a user device, according to at least one example. The user interface views 302-306 may be presented at the display 118 of the user device 106 using the application 110 and the arrangement service 128. As introduced herein, the user interface view 302 may be presented responsive to user selection of an event record similar to the event record 224. In the illustrated example, a user has selected an event record for an MLB game between Colorado and Seattle (e.g., using the user interface view 206). In response, the user interface view 302 is presented. The user interface view 302 presents an event record 308 (an example of the event record 224), bet selectors 310, amount selectors 312, custom amount input field 314, and an arrangement initiation button 316.

The arrangement (e.g., bet) selectors 310 may be used to select the type of arrangement the user desires to make. Illustrated examples, as described with respect to arrangement types 332, may include over/under wagers and line wagers. Using the flow described with respect to user interface views 302-306, the user may place a single arrangement. Thus, a single bet selector 310 may be selected.

The amount selectors 312 may be used to select an amount of the arrangement the user desires to make. Illustrated examples may include $10, $20, $30, $50, $75, and $100. In some examples, different amounts may be provided. In some examples, the amount of the arrangement may be capped at some predefined amount. For example, to reduce the possibility of large losses, the arrangement amount may be capped at $100, $200, $500, $1000, or at any other suitable amount. If the user desires to set a custom amount (e.g., $17), the user may use the custom input field 314. Once the bet has been selected and the amount has been selected, the arrangement initiation button 316 may be used to propose the arrangement, which may cause presentation of the user interface view 304.

The user interface view 304 presents the event record 308 and arrangement information that is specific to the arrangement proposed, using user interface view 302. In particular, the user interface view 304 includes the bet selector 310a (e.g., “SEA −1.5”) and the amount selector 312a (e.g., “$100”). The user interface view 304 presents win/loss information 318 that illustrates how much the user is set to win and how much the user is set to lose. In this example, assuming the arrangement request is accepted by an arrangement friend, because the user has placed an arrangement amount of $100, they are set to lose $100 if they lose the bet and set to earn $195 if they win. This takes into account the $100 that the arrangement friend would have to pay minus a 1.5% amount taken by the service provider for providing the transitory arrangement evaluation system. The user interface 304 also presents options for selecting an arrangement friend 320 from a tray of recent friends. In this example, only once recent friend (e.g., the friend 320) with whom the user has engaged. Thus, the tray includes a single arrangement friend 320. If an arrangement friend is not in the tray, the user may use arrangement friend addition button 322 to add a new arrangement friend. This may open the user's contact list on their user device (e.g., smartphone) and enable the user to select a friend to invite. Once the arrangement friend has been selected, a propose arrangement button 324 may be selected to send an arrangement request to the selected arrangement friend. In particular, this action may send the request to the service provider that can proxy the request to the selected arrangement friend (e.g., the arrangement friend 320).

The user interface view 306 presents an arrangement request summary 326. The arrangement request summary 326 includes a summary of the selections made in the user interface views 302 and 304 and informs the user that the arrangement request has been sent to arrangement friend 320.

FIG. 4 illustrates example user interface views 402-406 of a transitory arrangement evaluation system as viewed at a user device, according to at least one example. The user interface views 402-406 may be presented at the display 118 of the user device 106 using the application 110 and the arrangement service 128. The user interface views 402-406 are examples of the user interface views described above. User interface views 402-406 display wagers for NFL events that are a different sport from the major league baseball (MLB) event information displayed in FIG. 3. The wager can vary, and, for instance, the $20 wager in FIG. 4 is less than the $100 wager in FIG. 3. The difference in wager amounts may reflect that the user has lost money on the wager in FIG. 3 and the user has made a smaller wager in FIG. 4. The “recent” field in user interface view 404 can display recent profiles that the user has proposed arrangements to.

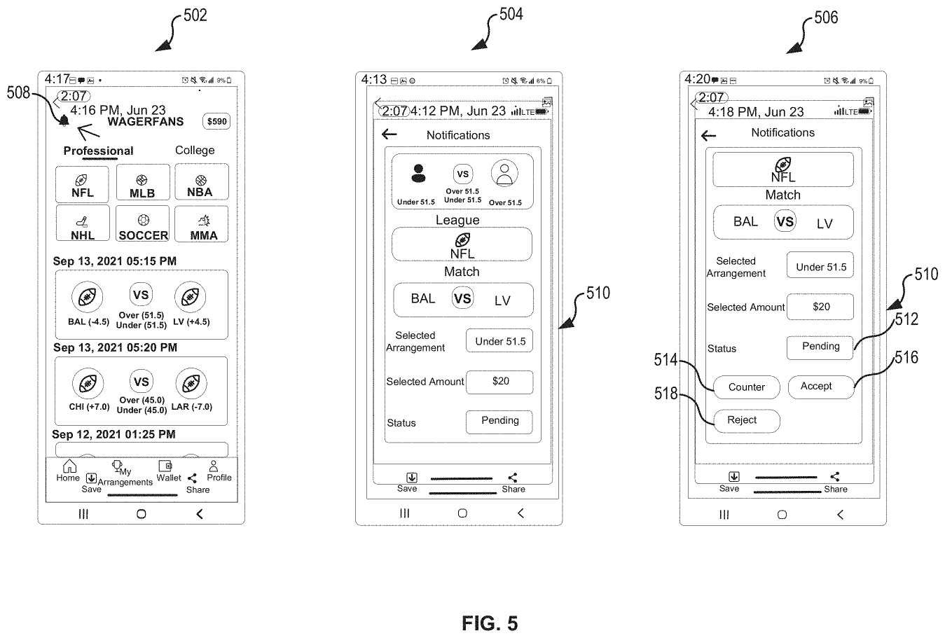

FIG. 5 illustrates example user interface views 502-506 of a transitory arrangement evaluation system as viewed at a user device, according to at least one example. The user interface views 502-506 may be presented at the display 118 of the user device 106 using the application 110 and the arrangement service 128. The user interface views 502-506 may be presented at a second user device, responsive to initiation of an arrangement request at a first device. For example, the user interface views 302 and 304 may be presented at the first user device and responsive to a first user placing an arrangement request using the user interface views 302 and 304, the service provider may receive the arrangement request and send it to the second user device. Upon reception of the arrangement request, the second user device may receive a notification, which may be presented in the notification icon 508, as shown in the user interface view 502. The user interface views 504 and 506 illustrate a popup 510, e.g., a top portion of the popup 510 in the user interface view 504 and a bottom portion of the popup 510 in the user interface view 506. The popup 510 includes arrangement information so that the receiving user (owner of the second user device) can make a decision about whether to accept, counter, or reject the request/offer. While displayed as a popup, the arrangement information can be presented in any other suitable manner. The status of the arrangement 512 can be displayed, and, for instance, the status can be “pending”, “rejected”, or “accepted”. The counter icon 514 can be selected to propose an alternative arrangement with an increase in the selected amount or a change in the selected arrangement. The user can accept the proposed arrangement by selecting an accept icon 516. The user can reject the proposed arrangement by selecting the reject icon 518. If the user accepts the arrangement by selecting the accept icon 516, a notification can be sent to a second user device. If the user rejects the arrangement by selecting the reject icon 518, a notification can be sent to the second user device. The second user device can present a received notification to a second user.

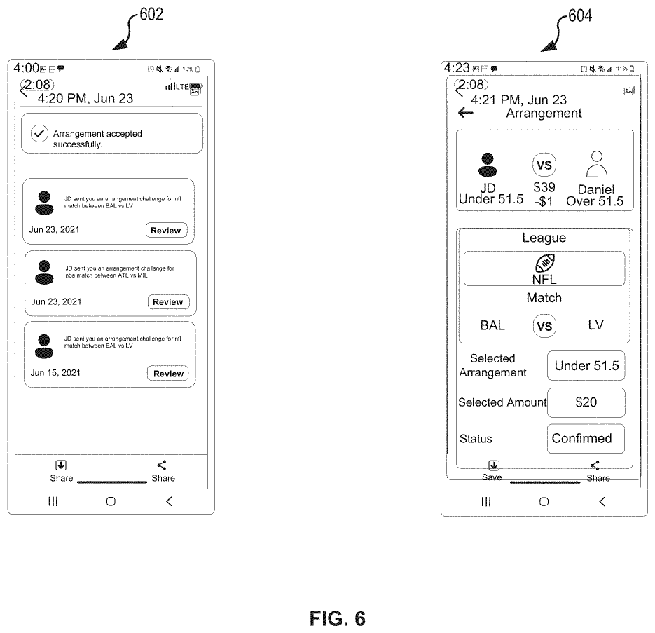

FIG. 6 illustrates example user interface views 602 and 604 of a transitory arrangement evaluation system as viewed at a user device, according to at least one example. The user interface views 602 and 604 may be presented at the display 118 of the user device 106 using the application 110 and the arrangement service 128. The user interface view 602 may be presented at the second user device, responsive to acceptance of the arrangement request at the second user device using the popup 510. Thus, the user interface view 602 includes a notification that the arrangement was “accepted successfully.” The user interface view 602 can include a notification that the arrangement was “rejected” or an “error” notification noting that the arrangement was not successfully accepted or rejected. Once accepted, the information about the arrangement may be updated into the “confirmed” user interface view on both the first user device and the second user device. A user can select the “confirmed” icon in the icon trey to see a confirmed wager.

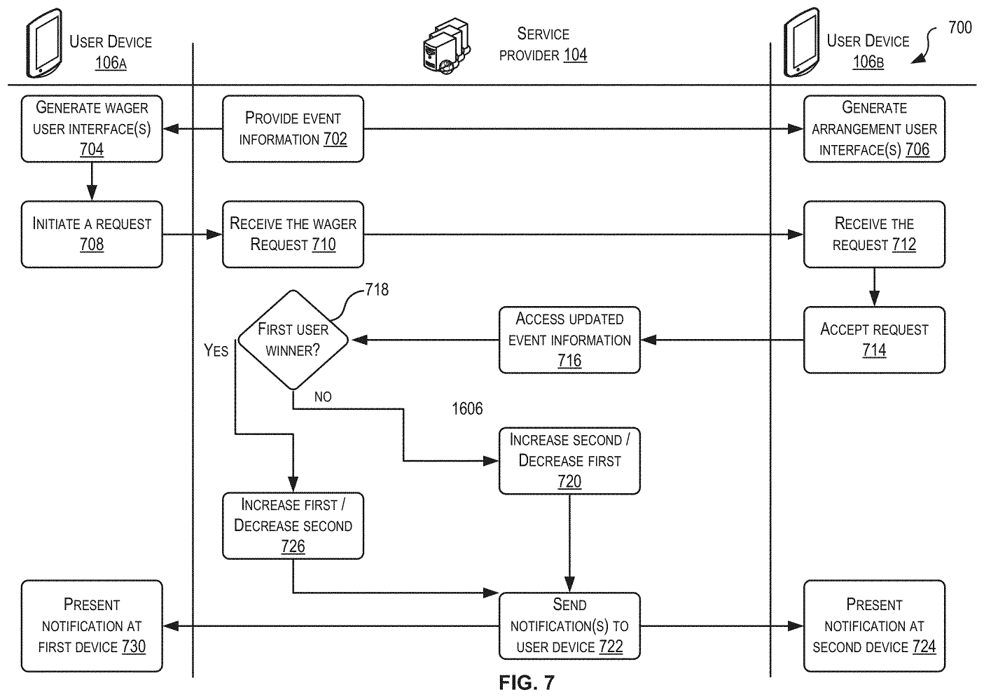

FIGS. 7, 8, and 9 illustrate example flow diagrams showing processes 700, 800, and 900, according to at least a few examples. These processes, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer readable storage medium, for example, in the form of a computer program including a plurality of instructions executable by one or more processors.

FIG. 7 illustrates an example flow chart depicting the process 700 for processing a request (e.g., wager request) using a transitory arrangement evaluation system, according to at least one example. The process 700 is performed by the arrangement service 128 (FIG. 1) executing in the service provider 104 (FIG. 1) and the application 70 (FIG. 1) executing in a first user device 106a operated by a first user and a second user device 106b operated by a second user.

The process 700 begins at block 702 by the service provider 104 providing event information to the user devices 106a and 106b. In some examples, the service provider 104 may generate the event information based on information received from the analytics services 105. The event information may identify a plurality of scheduled sporting events and odds information associated with each of the plurality of scheduled sporting events.

At blocks 704 and 706, the user devices 106a and 106b generate arrangement user interfaces such as those described with respect to FIGS. 2-6. For example, the user interface view 306 may be generated by populating it with the event information.

At block 708, the user device 106a initiates a request. This may be performed by the first user of the user device 106a proposing a request using the user interface views 306, 402, and 404.

At block 710, the user service provider 104 receives the request from the first user device 106a. The service provider 104 may send information about the request to the user device 106b, which may be received at block 712 and used by the user device 106b to populate a user interface view such as the user interface views 502-506.

At block 714, the user device 106b may be used to accept the request. This may performed a user accepting the request using the user interface 506. At block 716, the service provider 104 may access updated event information. This may include updates to the event upon which the request was based. The updated event information may be accessed from the analytics service 105. At block 718, the service provider 104 determine whether the first user is the winner of the request. This may be based on the updated event information accessed at 716. If the answer at block 718 is NO, the process 700 proceeds to block 720, at which, the service provider 120 credits a second account (associated with a second user of the second user device 106b) and debits a first account (associated with a first user of the first user device 106a).

In some examples, the updated event information accessed at 716 may include updating scoring information, information about a beginning or ending of an event, and the like. Thus, as the updated information is accessed, the service provider 104 may share that information with the user devices 106 to enable the user devices 106 to update their respective user interfaces accordingly. For example, once an event has begun, the user interfaces may be updated to show that no more arrangements may be submitted. As scores change, the user interfaces may be updated to show the updated scores. Additionally, when the event ends, the user interfaces may be updated. For example, a confirmed arrangement in user interface view may become a history arrangement in the user interface view after the final score is received and the winner identified. In some examples, the amounts in the wallet may also be updated. For example, the winning user may see an increase in their wallet, while the losing user may see a decrease.

At block 722, the service provider 104 can send one or more notification(s) to the second user device. The notification(s) can indicate that the second device is the winner or the loser. At block 724, the user device 106b may present the notification at the second user device. If the answer at block 118 is YES, the process 110 proceeds to block 726. At block 726, the service provider 104 increases (e.g., credits) the second account and decreases (e.g., debits) the first account. At block 722, the service provider 104 can send one or more notification(s) to the first user device. The notification(s) can indicate that the first device is the winner or the loser. At block 730, the user device 106a presents a notification to the first user device.

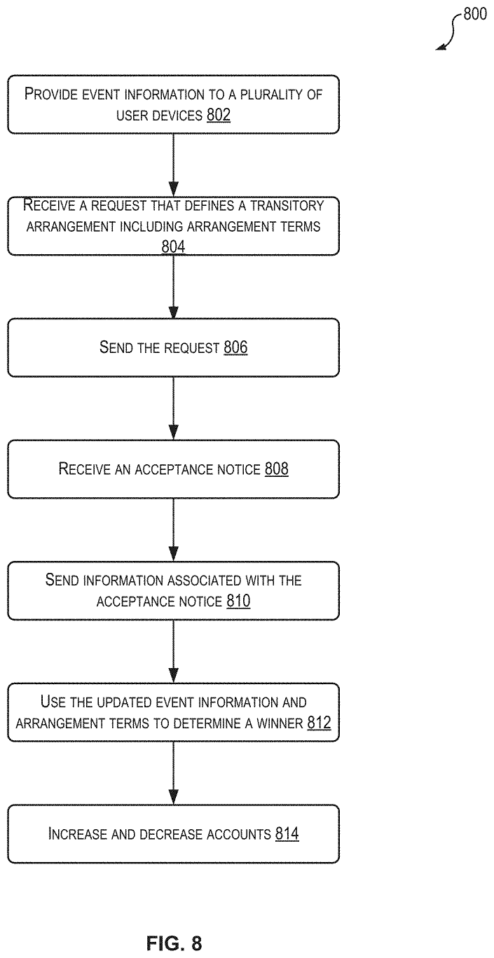

FIG. 8 illustrates an example flow chart depicting the process 800 for processing a request using a transitory arrangement evaluation system, according to at least one example. The process 800 is performed by the arrangement service 128 (FIG. 1) executing in the service provider 104 (FIG. 1). Process 800 may be performed at least in part by the user device, in some examples.

The process 800 begins at block 802 by the service provider 104 providing event information to a plurality of user devices. This may include providing, to the plurality of user devices each associated with at least one user profile, the event information that identifies a plurality of scheduled sporting events and odds information associated with each of the plurality of scheduled sporting events. In some examples, the event information may be received from an analytics service.

At block 804, the process 800 includes the service provider 104 receiving a request that defines an arrangement proposal including arrangement terms. This may include receiving from a first user device of the plurality of user devices associated with a first user profile. In some examples, the arrangement terms may identify at least: (i) a first sporting event of the plurality of sporting events, (ii) an arrangement amount, (iii) an arrangement type, and (iv) a second user profile.

At block 806, the process 800 includes the service provider 104 sending the request. This may include sending the request to a second user device associated with the second user profile. In some examples, the arrangement request is configured to enable the second user device to present information associated with the request. In some examples, sending the request may include sending a download request that requests downloading of an application on the second user device. The service provider 104 may determine that the first user device is in an approved geographic location prior to sending the request. The first user device may provide location information identifying a current location of the first user device to the service provider 104. The current location can be compared to a list of approved geographic locations to determine if the current location is in an approved geographic location. The service provider 104 may determine that the second user device is in an approved geographic location prior to sending the request. The second user device can send the device's current location to the service provider 104 and the current location can be compared to a list of approved geographic locations to determine if the current location is in an approved geographic location.

At block 808, the process 800 includes the service provider 104 receiving the acceptance notice. Receiving the acceptance notice may include receiving from the second user device. The acceptance may indicate user acceptance of the arrangement terms.

At block 810, the process 800 includes the service provider 104 sending information associated with the acceptance notice. The information associated with the acceptance notice may be sent to the first user device. The service provider 104 may determine that the second user device is located in an approved geographic location prior to sending the acceptance notice.

At block 812, the process 800 includes the service provider 104 using the updated event information and the arrangement terms to determine a prevailing user profile with respect to the transitory arrangement. This may be performed responsive to receiving updated event information (e.g., from the analytics service).

In some examples, the process 800 may further include, prior to receiving the updated event information, placing a hold on each of the first user account and the second account in an amount equal to the arrangement amount. In some examples, the first amount may be equal to two times the arrangement amount minus a service amount. The service or processing amount may be a fixed percentage of both amounts. For example, if the arrangement were for $100, the service amount may be assessed as a fixed percentage from the first user account (e.g., $2.50) and the same fixed percentage from the second user account (e.g., $2.50). The service amount may be used by a service provider to operate the transitory arrangement evaluation system.

At block 814, the process 800 includes the service provider 104, increasing a first account of the first user profile a first amount corresponding to the arrangement amount, and decreasing a second account of the second user profile a second amount equal to the arrangement amount. This may be performed, in the event the first user profile is the winner.

In some examples, the process 800 may further include the service provider 104 receiving the event information from a real-time event analytics service. The event information may include an aggregation of different odds information from a plurality of oddsmaker services.

In some examples, the process 800 may further include, prior to sending the request to the second user device, determining that the first user device is located within an approved geographic location for sports betting. In some examples, determining that the first user device is located within the approved location may include receiving location information from the first user device, the location information identifying a current location of the first user device, comparing the location information with a list of approved geographic locations comprising the approved geographic location, and determining based at least in part on the comparing that the current location is within the approved geographic location.

In some examples, herein at least one of the first user profile or the second user profile is associated with a contact stored respectively on at least one of the second user device or the first user device. In some examples, the process 800 may further include, in the event the second user profile is the winner: increasing the second account the first amount corresponding to the arrangement amount, and decreasing the first account the second amount equal to the arrangement amount.

In some examples, the process 800 may further include receiving, from the first user device, a debit request that identifies account details of an external account associated with the first user profile and a debit amount, confirming the account information, and requesting that the debit amount be sent to the external account.

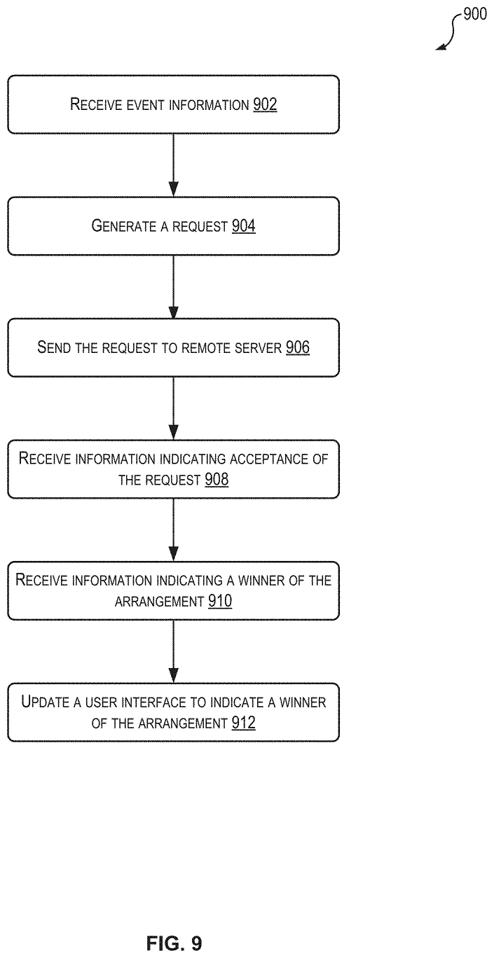

FIG. 9 illustrates an example flow chart depicting the process 900 for processing a request using a transitory arrangement evaluation system, according to at least one example. The process 900 is performed by the application 110 (FIG. 1) executing in the user device 106 (FIG. 1). Process 900 may be performed at least in part by a user device, in some examples.

The process 900 begins at block 902 by the user device 106 receiving event information. This may be received at a user device associated with a first user profile. The event information may identify a plurality of scheduled sporting events and odds information associated with each of the plurality of scheduled sporting events. In some examples, the odds information may identify at least one of an over/under for each scheduled sporting event or a point spread for each scheduled sporting event.

At block 904, the process 900 includes the user device 106 generating a request. This may be based at least in part on user input. The request may define a arrangement including arrangement terms that identify at least: (i) a first sporting event of the plurality of sporting events, (ii) an arrangement amount, (iii) an arrangement type, and (iv) a second user profile. In some examples, the second user profile may be associated with a contact of the first user profile and that is stored on the user device.

At block 906, the process 900 includes the user device 106 sending the request to a remote server such as the service provider 104. In some examples, the request may be configured to enable the remote server to share the request with a different user device associated with the second user profile. In some examples, sending the request may occur at a first time and receiving the information indicating the winner of the arrangement occurs at a second time that is later than the first time. The request may be sent with information indicating a current location for the user device 106.

At block 908, the process 900 includes the user device 106 receiving information indicating acceptance of the request. This may be received from the service provider 104.

At block 910, the process 900 includes the user device 106 receiving information indicating a prevailing user profile with respect to the transitory arrangement.

At block 912, the process 900 includes the user device 106 updating a user interface to indicate a prevailing user profile with respect to the transitory arrangement. This may be based at least in part on the information indicating the winner of the arrangement.

In some examples, the process 900 may further include sending location information to the remote server that identifies a current location of the user device. The location information may be configured to enable the remote server to determine whether to accept or reject the request.

In some examples, the process 900 may further include determining a current location of the user device, determining whether the current location is within a permissive boundary, in accordance with a determination that the current location is within the permissive boundary, sending the request, and in accordance with a determination that the current location is outside the permissive boundary, preventing the user device from sending the request. In some examples, the permissive boundary may be one of a plurality of permissive boundaries each corresponding to a state boundary.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
providing, to a plurality of user devices each associated with at least one user profile, event information that identifies a plurality of predetermined events and likelihood information associated with each of the plurality of predetermined events;
receiving, from a first user device of the plurality of user devices associated with a first user profile, a request that defines a transitory arrangement including arrangement terms that identify at least: (i) a first event of the plurality of predetermined events, (ii) an amount, (iii) an arrangement type, and (iv) a second user profile;
sending, to a second user device associated with the second user profile, the request, wherein the request is configured to enable the second user device to present information associated with the request;
receiving an acceptance notice from the second user device, the acceptance notice indicating user acceptance of the arrangement terms;
sending, to the first user device, information associated with the acceptance notice;
responsive to receiving updated event information, using the updated event information and the arrangement terms to determine a prevailing user profile with respect to the transitory arrangement;
if the first user profile is the prevailing user profile:
increasing a first repository of the first user profile a first amount corresponding to the amount; and
decreasing a second repository of the second user profile a second amount equal to the amount.

2. The computer-implemented method of claim 1, further comprising receiving the event information from a real-time event analytics service, wherein the event information comprises an aggregation of different likelihood information from a plurality of likelihood services.

3. The computer-implemented method of claim 1, further comprising prior to sending the request to the second user device, determining that the first user device is located within an approved geographic location for making transitory arrangements.

4. The computer-implemented method of claim 3, wherein determining that the first user device is located within the approved geographic location comprises:
receiving location information from the first user device, the location information identifying a current location of the first user device;
comparing the location information with a list of approved geographic locations comprising the approved geographic location; and
determining based at least in part on the comparing that the current location is within the approved geographic location.

5. The computer-implemented method of claim 1, further comprising prior to sending the request to the second user device, determining that the second user device is located within an approved geographic location for making transitory arrangements.

6. The computer-implemented method of claim 5, wherein determining that the second user device is located within the approved geographic location comprises:
receiving location information from the second user device, the location information identifying a current location of the second user device;
comparing the location information with a list of approved geographic locations comprising the approved geographic location; and
determining based at least in part on the comparing that the current location is within the approved geographic location.

7. The computer-implemented method of claim 1, wherein at least one of the first user profile or the second user profile is associated with a contact stored respectively on at least one of the second user device or the first user device.

8. The computer-implemented method of claim 1, if the second user profile is the prevailing user profile:
increasing the second repository the first amount corresponding to the amount; and
decreasing the first repository the second amount equal to the amount.

9. The computer-implemented method of claim 1, wherein sending the request further comprises sending a download request that requests downloading of an application on the second user device.

10. The computer-implemented method of claim 1, further comprising:
receiving, from the first user device, a debit request that identifies repository details of an external repository associated with the first user profile and a debit amount;
confirming the repository details; and
requesting that the debit amount be sent to the external repository.

11. A computer-implemented method, comprising:
receiving, at a user device associated with a first user profile, event information that identifies a plurality of predetermined events and likelihood information associated with each of the plurality of predetermined events;
generating a request based at least in part on user input, the request defining an arrangement including arrangement terms that identify at least: (i) a first event of the plurality of predetermined events, (ii) an amount, (iii) an arrangement type, and (iv) a second user profile;
sending, to a remote server, the request;
receiving, from the remote server, information indicating acceptance of the request;
receiving information indicating a prevailing user profile with respect to the transitory arrangement; and
updating a user interface of the user device based at least in part on the information indicating the prevailing user profile of the arrangement.

12. The computer-implemented method of claim 11, further comprising sending location information to the remote server that identifies a current location of the user device, the location information configured to enable the remote server to determine whether to accept or reject the request.

13. The computer-implemented method of claim 11, wherein the second user profile is associated with a contact of the first user profile and that is stored on the user device.

14. The computer-implemented method of claim 11, wherein the request is configured to enable the remote server to share the request with a different user device associated with the second user profile.

15. The computer-implemented method of claim 11, wherein the likelihood information identifies at least one of an over/under for each predetermined event or a point spread for each predetermined event.

16. The computer-implemented method of claim 11, wherein sending the request occurs at a first time and receiving the information indicating the prevailing user profile occurs at a second time that is later than the first time.

17. The computer-implemented method of claim 11, further comprising:
determining a current location of the user device;
determining whether the current location is within a permissive boundary;
in accordance with a determination that the current location is within the permissive boundary, sending the request; and
in accordance with a determination that the current location is outside the permissive boundary, preventing the user device from sending the request.

18. The computer-implemented method of claim 11, wherein the request includes location information for the user device.

19. The computer-implemented method of claim 11, wherein the request includes a unique identifier of the second user profile.

20. A non-transitory computer-readable medium storing a plurality of instructions that, when executed by one or more processors of a user device, cause the user device to perform operations comprising:
receiving, at the user device associated with a first user profile, event information that identifies a plurality of predetermined events and likelihood information associated with each of the plurality of predetermined events;
generating a request based at least in part on user input, the request defining an arrangement including arrangement terms that identify at least: (i) a first event of the plurality of predetermined events, (ii) an amount, (iii) an arrangement type, and (iv) a second user profile;
sending, to a remote server, the request;
receiving, from the remote server, information indicating acceptance of the request;
receiving information indicating a prevailing user profile with respect to the transitory arrangement; and
updating a user interface of the user device based at least in part on the information indicating the prevailing user profile of the arrangement.
